(19) United States
(12) Patent Application Publication
(10) Pub. No.: US 2020/0371535 A1
(43) Pub. Date: Nov. 26, 2020

(54) AUTOMATIC IMAGE CAPTURING METHOD AND DEVICE, UNMANNED AERIAL VEHICLE AND STORAGE MEDIUM

(71) Applicant: SZ DJI TECHNOLOGY CO., LTD., Shenzhen (CN)

(72) Inventors: Sijin LI, Shenzhen (CN); Cong ZHAO, Shenzhen (CN); Liliang ZHANG, Shenzhen (CN)

(21) Appl. No.: 16/994,092

(22) Filed: Aug. 14, 2020

Related U.S. Application Data
(63) Continuation of application No. PCT/CN2018/076792, filed on Feb. 14, 2018.

(51) Int. Cl. G05D 1/12; G05D 1/00; B64C 39/02; G06K 9/62; G06N 20/00

(52) U.S. Cl. CPC G05D 1/12; G05D 1/0094; B64C 2201/127; G06K 9/6269; G06N 20/00; B64C 39/024

(57) ABSTRACT

An automatic image capturing method includes obtaining an image-to-be-processed, pre-processing the image-to-be-processed to obtain a pre-processing result, inputting the pre-processing result into a trained machine learning model for classification, and generating and transmitting a control signal according to the classification. The control signal is configured to perform a preset operation to the image-to-be-processed.

### CROSS-REFERENCE TO RELATED APPLICATION

This application is a continuation of International Application No. PCT/CN2018/076792, filed on Feb. 14, 2018, the entire content of which is incorporated herein by reference.

### TECHNICAL FIELD

The present disclosure relates to the field of image processing, and in particular relates to an automatic image capturing method and device, unmanned aerial vehicle (UAV), and storage medium.

### BACKGROUND

Currently, there are two main photographing methods. One way is to take selfies, that is, use your smartphone, tablet, etc. to take a selfie, or use a selfie stick to assist in selfies. This photographing method has limitations. On the one hand, it is only suitable for occasions with a relatively small number of people. If multiple people travel, the selfie photographing effect is not good enough to achieve the expected effect. On the other hand, the adjustment of the photographing angle is not flexible enough when taking selfies, and people's facial expressions and gestures also appear unnatural.

Another way is to seek help from others for photographing, that is, to temporarily give your own photographing device to others, and ask others to help taking pictures. This photographing method has the following shortcomings. On the one hand, it may be necessary to seek help from others, it may be difficult to promptly find another person for help in a place with few people. On the other hand, the photography abilities of others cannot be guaranteed and sometimes the photographing effect can be very poor.

Further, the above two photographing methods are used when a user is posing for a photo. As such, the movements are relatively few, and the captured images are not natural.

A user can hire an accompanying professional photographer to follow and record. Although this method can ensure the photographing effect, and at the same time, the user need not take pictures by himself or seek help from others, it costs more for individuals and may not be suitable for daily trips or longer travels. Generally, it is used by more wealthy families for special occasions.

Accordingly, there is a need for a new automatic image capturing method and device, UAV and storage medium.

### SUMMARY

According to one aspect of the present disclosure, there is provided an automatic image capturing method. The method includes obtaining an image-to-be-processed, pre-processing the image-to-be-processed to obtain a pre-processing result, inputting the pre-processing result into a trained machine learning model for classification, and generating and transmitting a control signal according to the classification. The control signal is configured to perform a preset operation to the image-to-be-processed.

According to a further aspect of the present disclosure, there is provided an automatic image capturing device. The automatic image capturing device includes an image acquisition module configured to obtain an image-to-be-processed, a pre-processing module configured to pre-process the image-to-be-processed to obtain a pre-processing result, a classification module configured to input the pre-processing results into a trained machine learning model for classification, and a control module configured to generate and transmit a control signal according to the classification. The control signal is configured to perform a preset operation to the image-to-be-processed.

According to a further aspect of the present disclosure, there is provided a UAV. The UAV includes a body, a photographing device disposed on the body, and a processor. The processor is configured to: obtain an image-to-be-processed; pre-process the image-to-be-processed to obtain a pre-processing result; input the pre-processing result into a trained machine learning model for classification; and generate and transmit a control signal according to the classification. The control signal is configured to perform a preset operation to the image-to-be-processed.

### BRIEF DESCRIPTION OF THE DRAWINGS

FIG. 1 illustrates a flowchart of an automatic image capturing method according to an embodiment of the present disclosure;

FIG. 2 illustrates a flowchart of S120 of the automatic image capturing method according to an embodiment of the present disclosure;

FIG. 3 is a schematic diagram of an automatic image capturing device according to an embodiment of the present disclosure; and

FIG. 4 is a schematic diagram of a UAV according to an embodiment of the present disclosure.

### DETAILED DESCRIPTION OF THE EMBODIMENTS

The principle and spirit of the present disclosure will be described below with reference to several exemplary embodiments. It should be understood that these embodiments are given only to enable those skilled in the art to better understand and implement the present disclosure, and do not limit the scope of the present disclosure in any manner. On the contrary, these embodiments are provided to make the present disclosure more thorough and complete, and to fully convey the scope of the present disclosure to those skilled in the art.

As known by those skilled in the art, the embodiments of the present disclosure may be implemented as a system, an apparatus, a device, a method, or a computer program product. Therefore, the present disclosure may be specifically implemented in the form of complete hardware, complete software (including firmware, resident software, microcode, etc.), or a combination of hardware and software.

According to an embodiment of the present disclosure, a method for automatic capturing of image, a UAV, and a storage medium are provided. The principle and spirit of the present disclosure will be explained in detail below with reference to several representative embodiments of the present disclosure.

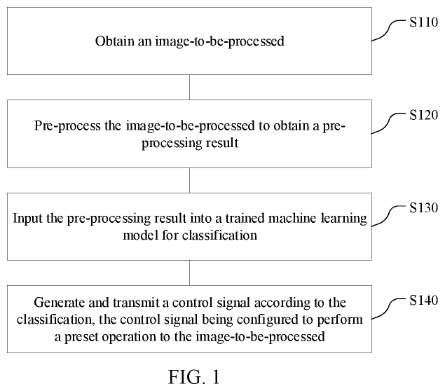

FIG. 1 is a flowchart of an automatic image capturing method according to an embodiment of the present disclosure. As shown in FIG. 1, the method of this embodiment includes S110-S140.

In S110, an image-to-be-processed is obtained.

In this embodiment, the image of a user's environment can be captured in real-time by a photographing device of a smart device, and the image-to-be-processed can be obtained from the captured image.

The smart device may be a UAV, and the image-to-be-processed may be a frame of image in a video recorded by the UAV. For example, the user can operate the UAV to fly in an environment where the user is located, and control the UAV to capture images of the user in real-time through the photographing device installed on the UAV to obtain a piece of video. Any frame of the video may be extracted to be the image-to-be-processed.

In other embodiments of the present disclosure, the smart device may also be any of: a hand-held gimbal, a vehicle, a vessel, an autonomous driving vehicle, an intelligent robot, etc., as long as the smart device has a photographing device and can perform mobile recording, which will not be listed here one by one.

In S120, the image-to-be-processed may be pre-processed to obtain a pre-processing result.

In an embodiment, S120 may include S1210.

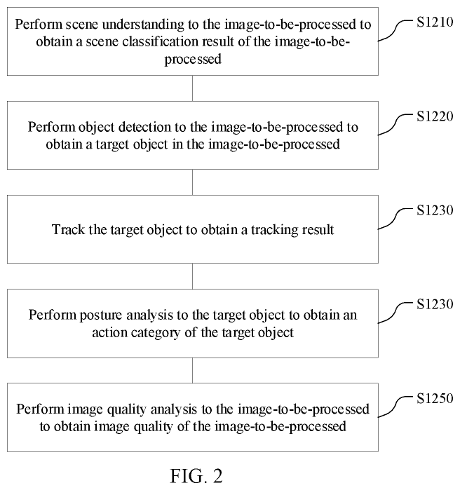

As shown in FIG. 2, in S1210, scene understanding may be performed to the image-to-be-processed to obtain a scene classification result of the image-to-be-processed.

Deep learning method may be implemented for scene understanding, but the present disclosure does not limit this, and in other embodiments, other methods may also be adopted.

The obtained scene classification result may include any of: a seaside, a forest, a city, an indoor space, a desert, etc., but is not limited to these. For example, it may also include other scenes such as a public square or city center.

For example, multiple test pictures can be selected, and each test picture of the multiple test pictures (e.g., each test picture may include multiple test pictures of the same type) corresponds to a scene classification. The scene classification may include any of: a seaside, a forest, a city, an indoor space, a desert, etc. Based on the multiple test pictures, a network model containing one or more scene classifications can be trained through deep learning. The network model may include a convolution layer and a fully connected layer.

The features of the image-to-be-processed can be extracted through the convolutional layer, and then the extracted feature can be integrated through the fully connected layer such that the features of the image-to-be-processed may be compared with the one or more scene classifications described above to determine the scene classification result, e.g., seaside, of the image-to-be-processed.

In an embodiment, S120 may further include S1220 and S1230.

As shown in FIG. 2, in S1220, object detection may be performed to the image-to-be-processed to obtain a target object in the image-to-be-processed.

In the embodiment of the present disclosure, the target object may be, for example, a pedestrian in the image-to-be-processed, and in other embodiments, it may also be another object such as an animal. In the following embodiments, the target object is a pedestrian as an example for illustration.

In an exemplary embodiment, a pedestrian detection algorithm may be used to detect pedestrians in the image-to-be-processed, to obtain all pedestrians in the image-to-be-processed, which may be sent to a terminal device (e.g., the terminal device may be installed an application program) such as a mobile phone, a tablet computer, and so on. The user can select the pedestrian to be photographed, that is, the target object, or the person who needs to be captured, from all the pedestrians in the image-to-be-processed through the terminal device.

For example, a pedestrian detection method based on a multi-layer network model can be used to identify all pedestrians in the image-to-be-processed. Specifically, a multi-layer convolutional neural network may be used to extract candidate positions of the pedestrians, and then all the candidate positions may be verified through the neural network of the second stage to refine a prediction result, and a tracking frame may be used to link the detection of the pedestrians in multiple frames.

The user can receive the to-be-processed image and each person on the to-be-processed image selected by the tracking frame through the terminal device, and select the tracking frame of a person that the user wishes to capture to determine a target object. The target object and the user who operates the terminal device may be the same person or different persons.

In S1230, the target object may be tracked to obtain a tracking result.

In an exemplary embodiment, the tracking result may include a position or a size of the target object in the image-to-be-processed, and of course, may also include both the position and the size.

In this embodiment, the target object can be selected from the image-to-be-processed and tracked in real-time by comparing the information of a frame prior to the image-to-be-processed or an initial frame.

For example, the position of each pedestrian in the image-to-be-processed can be obtained first, and then the tracking algorithm can be used to match the image-to-be-processed with the image of the previous frame. The tracking frame can be used to frame the pedestrian, and position of the tracking frame may be updated in real-time to determine the position and size of the pedestrian in real-time. The position of the pedestrian may be identified using coordinates of the pedestrian in the image-to-be-processed, and the size of the pedestrian may be an area of a region occupied by the pedestrian in the image-to-be-processed.

In S1240, posture analysis may be performed to the target object to obtain an action category of the target object.

In the embodiment of the present disclosure, the posture analysis method may be a detection method based on morphological features; that is, a detector is trained based on each human joint, and then these joints are combined into a human posture using a rule-based or optimization method. Alternatively, the posture analysis method may also be a regression method based on global information; that is, directly predict the position (e.g., coordinates) of each joint point in the image, and determine the action category based on the calculated joint position classification. Of course, other methods can also be used for posture analysis, which will not be listed here.

The action category of the target object may include any of: running, walking, jumping, etc., but is not limited to these actions. For example, it may also include action categories such as bending, rolling, swinging, etc.

In an embodiment, S120 may further include S1250.

As shown in FIG. 2, in S1250, image quality analysis is performed to the image-to-be-processed to obtain image quality of the image-to-be-processed.

In this embodiment, the image quality of the image-to-be-processed can be analyzed by using the peak signal-to-noise ratio (PSNR) and the mean square error (MSE) full-reference evaluation algorithm or other algorithms to obtain image quality of the image-to-be-processed. The image quality of the image-to-be-processed may be represented by multiple scores, or may be represented by specific numerical values of parameters that reflect the image quality, such as clarity.

In S130, the pre-processing result may be input into a trained machine learning model for classification.

In an exemplary embodiment, the pre-processing result may include any one or a combination of: a scene classification result, a target object, a tracking result, an action category, and image quality in the above-mentioned embodiments.

In one embodiment, the trained machine learning model may be a deep learning neural network model, which may be obtained based on posture analysis, pedestrian detection, pedestrian tracking, and scene analysis algorithms, in combination with preset evaluation standard training. A formation process may include, e.g., establishing evaluation standard, labeling samples according to the evaluation standard, and training models based on machine learning algorithms.

The evaluation standard may be proposed by experts or amateurs in photography. In this embodiment, according to different photography factions, photography experts of different factions may propose more subdivided evaluation standard for different factions, such as evaluation standard suitable for recording people and evaluation standard suitable for recording natural scenery, or evaluation standard suitable for retro style, or evaluation standard suitable for fresh style, and so on.

In another embodiment, the trained machine learning model may be a deep learning neural network model, which may be obtained through training based on algorithms such as posture analysis, pedestrian detection, pedestrian tracking, scene analysis, and image quality analysis, in combination with the preset evaluation standard and the photographing parameters of the photographing device. The formation process may include establishing evaluation standard, labeling samples according to the evaluation standard, and training models based on machine learning algorithms.

For example, when given a photo, the photo may be annotated by analyzing image clarity of the photo and obtaining the photographing parameters of the photographing device, and the annotations may be input into the machine learning model for training. The trained model can predict whether the photographing parameters of the photographing device that records the to-be-processed image need to be adjusted according to the image quality of the to-be-processed image.

In this embodiment, the trained machine learning model may score the to-be-processed image according to the pre-processing result, and the scoring basis may be one or more of: a scene classification result, a target object, a tracking result, and an action category. The obtained score is compared with a preset threshold to determine the classification of the image-to-be-processed.

For example, when the score of the image-to-be-processed is higher than the threshold, it can be classified as a first classification. At this time, a corresponding image-to-be-processed can be saved and the image-to-be-processed can be sent to a user terminal device. When the score of the image-to-be-processed is lower than the threshold, the image-to-be-processed may be deleted.

In an embodiment, the image-to-be-processed may be scored based on a single scene classification result. For example, when the scene classification result of the image-to-be-processed is a beach, it may be classified as the first classification and the image-to-be-processed may be retained.

In another embodiment, the image-to-be-processed may be scored based on the tracking result of the target object. For example, when it is determined that there are multiple target objects to be captured, when it is detected that the multiple target objects are at a middle position of the image-to-be-processed at the same time, it may be determined that the multiple target objects currently wish to take a group photo. At this time, the image-to-be-processed may be classified into the first category, and the corresponding image-to-be-processed may be retained. In another example, when it is known from the tracking result that the target object occupies more than ½ (this value can be adjusted according to specific circumstances) of the area of the image-to-be-processed, it can be determined that the target object currently wishes to take a photo and deliberately walks to a more suitable location for the UAV. At this time, the image-to-be-processed can be classified into the first category, and the corresponding image-to-be-processed can be saved.

In another embodiment, the image-to-be-processed may also be scored based on a single action category. For example, when it is detected that the target object currently has a jumping action, and the jumping action reaches a first preset height such as 1 meter, then the image-to-be-processed may be scored 10 points, the image-to-be-processed may be in the first category, and the image-to-be-processed may be retained. When it is detected that the target object currently has a jump action, and the jump action reaches a second preset height such as 50 cm, then the image-to-be-processed may be scored 5 points, the image-to-be-processed may be in the second category, and the image-to-be-processed may be deleted.

In another embodiment, scoring may result from comprehensive consideration based on the scene classification result and the target object of pedestrian detection. When the scene classification result well matches the target object, the image-to-be-processed belongs to the first classification; and when the scene classification result does not match the target object, the image-to-be-processed belongs to the second classification. Whether the scene classification result and the target object match here can be predicted and learned by the machine learning model based on massive annotated photo training.

For example, in a seaside scene, when the target object and the sea are detected, and there are no other idle people in the current shot (i.e., objects not intended to be captured), the image-to-be-processed can be classified into the first category, and the corresponding image-to-be-processed can be saved.

In another embodiment, the image-to-be-processed may be scored by comprehensively considering the scene classification result, the tracking result of the target object, and the action category of the target object. For example, when the scene classification result of the to-be-processed image is grassland, the tracking result shows that the target object is near a middle position of the to-be-processed image, the target object occupies more than ⅓ of the area of the to-be-processed image, and at the same time, the target object makes a victory sign or other common photographing gestures, it can be determined that the image-to-be-processed is in the first category, and the image-to-be-processed may be saved.

In the embodiment of the present disclosure, when it can be determined that the scene classification result does not match the target object, or the position and/or size of the target object does not meet the photographing requirements, or the action category of the target object does not match the current scene classification result, the image-to-be-processed is classified into the second classification, and the image-to-be-processed may be deleted.

In an exemplary embodiment, while scoring the image-to-be-processed, the machine learning model may also classify the image-to-be-processed according to the image quality.

For example, when the score of the image quality of the image to-be-processed is lower than a threshold, the image to-be-processed may be classified into a third category. At this time, the image quality is poor, and the machine learning model may generate photographing adjustment parameters based on the image quality, to adjust the photographing parameters of the photographing device according to the photographing adjustment parameters to improve subsequent image quality.

The photographing adjustment parameters may include any one or more of: an adjustment amount of the aperture of the photographing device, an exposure parameter, a focal distance, a contrast, etc., which is not specifically limited herein. In addition, the photographing adjustment parameters may also include an amount of adjustment of parameters such as a photographing angle or a photographing distance.

In S140, a control signal is generated and transmitted according to the classification, and the control signal is configured to perform a corresponding preset operation to the image-to-be-processed.

In the embodiment of the present disclosure, each of the above categories may correspond to a control signal, and each control signal may correspond to a different preset operation. The preset operation may include any one of: a saving operation, a deletion operation, a retake operation, or the like.

For example, when the classification of an image-to-be-processed is the above-mentioned first classification, a first control signal may be generated, and the first control signal is configured to perform a saving operation to the corresponding pre-processed image, thereby saving the pre-processed image, which makes it convenient for users.

When the classification of an image-to-be-processed is the above-mentioned second classification, a second control signal may be generated, and the second control signal is configured to perform a deletion operation on the corresponding pre-processed image.

When the classification of an image-to-be-processed is the above-mentioned third classification, a third control signal may be generated, and the third control signal is configured to obtain corresponding photographing adjustment parameters according to the corresponding image-to-be-processed, and then, perform a deletion operation and retake operation to the-image-to-be-processed. The retake operation may include: adjusting the photographing parameters of the photographing device and/or the UAV according to the photographing adjustment parameters, and obtaining another image-to-be-processed by the adjusted UAV and the photographing device installed thereon. The other image-to-be-processed may be processed according to the above-mentioned automatic image capturing method.

It can be understood that the above-mentioned automatic image capturing method can be applied to any of: a UAV, a hand-held gimbal, a vehicle, a vessel, an autonomous vehicle, an intelligent robot, or the like.

It should be noted that the above examples are only the preferred embodiments of steps S110-S140, but the embodiments of the present disclosure are not limited to these, and those skilled in the art can easily think of other implementations within the scope of the disclosure based on the above disclosure.

In the automatic image capturing method of the embodiment of the present disclosure, natural and elegant pictures, actions, and scenes can be conveniently captured during the travel. At the same time, the implementation cost of this automatic image capturing can be relatively low. And by pre-processing the current image-to-be-processed, and classifying the pre-processing results by the trained machine learning model, corresponding presetting operation may be performed to the current image-to-be-processed according to the classification result. Accordingly, compared to the existing technology, not only the function of automatic image capturing can be implemented, but the photographing effect of the photo automatically captured can also be ensured.

It should be noted that although the steps of the method in the present disclosure are described in a specific order in the drawings, this does not require or imply that the steps must be performed in the specific order, or all the steps shown must be performed to achieve the desired result. Some of the additional or alternative steps may be omitted, multiple steps may be combined into one step for execution, and/or one step may be decomposed into multiple steps for execution, and so on. In addition, it can also be easily understood that these steps may be performed synchronously or asynchronously, e.g., in multiple modules/processes/threads.

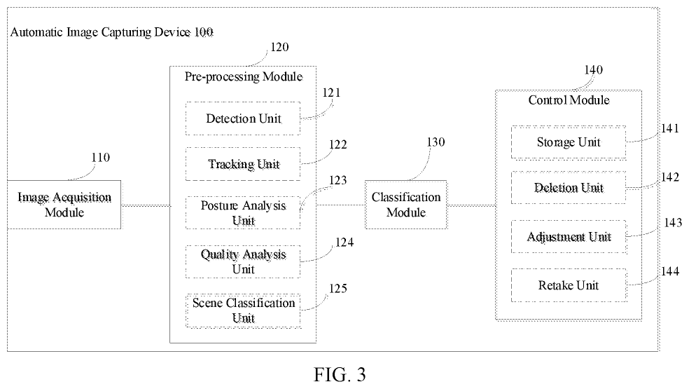

FIG. 3 is a schematic diagram of an automatic image capturing device according to an embodiment of the present disclosure. As shown in FIG. 3, the automatic image capturing device 100 may include an image acquisition module 110, a pre-processing module 120, a classification module 130, and a control module 140.

In an embodiment, the image acquisition module 110 may be configured to obtain the image-to-be-processed. For example, the image acquisition module 110 may include a photographing unit 111, which may be configured to obtain the image-to-be-processed by photography through a photographing device on the smart device.

In an embodiment, the pre-processing module 120 may be configured to pre-process the image-to-be-processed to obtain a pre-processing result. For example, the pre-processing module 120 may include any one or a combination of: a detection unit 121, a tracking unit 122, a posture analysis unit 123, a quality analysis unit 124, and a scene classification unit 125.

The detection unit 121 may be configured to perform object detection on the image-to-be-processed to obtain a target object in the image-to-be-processed.

The tracking unit 122 may be configured to track the target object to obtain a tracking result.

In an exemplary embodiment, the tracking result may include the position and/or size of the target object in the image-to-be-processed.

The posture analysis unit 123 may be configured to perform posture analysis on the target object to obtain an action category of the target object.

In an exemplary embodiment, the action category may include any of: running, walking, jumping, or the like.

The quality analysis unit 124 may be configured to perform image quality analysis on the image-to-be-processed to obtain the image quality of the image-to-be-processed.

The scene classification unit 125 may be configured to perform scene understanding on the image-to-be-processed and obtain a scene classification result of the image-to-be-processed.

In an exemplary embodiment, the scene classification result may include any of: a seaside, a forest, a city, an indoor, and a desert.

In an embodiment, the classification module 130 may be configured to input the pre-processing results into the trained machine learning model for classification.

In an embodiment, the control module 140 may be configured to generate and transmit a control signal according to the classification, and the control signal is configured to perform a corresponding preset operation on the image-to-be-processed.

For example, the control module 140 may include a storage unit 141 and a deletion unit 142.

The storage unit 141 may be configured to save the image-to-be-processed when the classification is the first classification.

The deletion unit 142 may be configured to perform a deletion operation on the image-to-be-processed when the classification is the second classification.

In an exemplary embodiment, the control module 140 may further include an adjustment unit 143 and a retake unit 144.

The adjustment unit 143 may be configured to obtain corresponding photographing adjustment parameters according to the image-to-be-processed when the classification is the third classification.

The retake unit 144 may be configured to perform a deletion operation on the image-to-be-processed, and obtain another image-to-be-processed according to the photographing adjustment parameters.

In an exemplary embodiment, the photographing adjustment parameters may include any one or more of: an aperture adjustment amount, an exposure parameter, a focal distance, a photographing angle, and the like.

It can be understood that the above-mentioned automatic image capturing device can be applied to any of: a UAV, a hand-held gimbal, a vehicle, a vessel, an autonomous driving vehicle, an intelligent robot, or the like.

The specific principle and implementation of the automatic image capturing device provided by the embodiments of the present disclosure have been described in detail in the embodiments related to the method, and will not be repeated here.

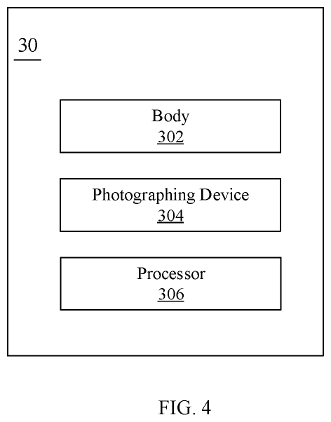

FIG. 4 is a schematic diagram of a UAV according to an embodiment of the present disclosure. As shown in FIG. 4, a UAV 30 may include: a body 302, a photographing device 304 disposed on the body, and a processor 306. The processor 306 is configured to: obtain an image-to-be-processed; pre-process the image-to-be-processed to obtain a pre-processing result; input the pre-processing result into a trained machine learning model for classification; and generate and transmit a control signal according to the classification. The control signal is configured to perform corresponding preset operation to the image-to-be-processed.

In an embodiment, the processor 306 is further configured to perform the following functions: perform scene understanding to the image-to-be-processed, and obtain a scene classification result of the image-to-be-processed.

In an embodiment, the processor 306 is further configured to perform the following functions: perform object detection to the image-to-be-processed, and obtain a target object in the image-to-be-processed.

In an embodiment, the processor 306 is further configured to perform the following function: track the target object and obtain a tracking result.

In an embodiment, the processor 306 is further configured to perform the following function: perform posture analysis to the target object to obtain an action category of the target object.

It can be understood that, in other application scenarios, the above-mentioned UAV can be replaced with any of: a hand-held gimbal, a vehicle, a vessel, an autonomous driving vehicle, an intelligent robot, or the like.

The specific principle and implementation of the UAV provided by the embodiments of the present disclosure have been described in detail in the embodiments related to the method, and will not be repeated here.

It should be noted that although several modules or units of the device for action execution are mentioned in the above detailed description, this division is not mandatory. In fact, according to the embodiments of the present disclosure, the features and functions of the two or more modules or units described above may be embodied in one module or unit. Conversely, the features and functions of a module or unit described above can be further divided into multiple modules or units to be embodied. The components displayed as modules or units may or may not be physical units; that is, they may be located at one place, or may be distributed on multiple network units. Some or all, of the modules can be selected according to actual needs to achieve the purpose of the present disclosure. Those of ordinary skill in the art can understand and implement without making creative efforts.

This example embodiment also provides a computer-readable storage medium on which a computer program is stored. When the program is executed by a processor, the steps of the automatic image capturing method described in any one of the foregoing embodiments may be implemented. For the specific steps of the automatic image capturing method, reference may be made to the detailed description of the steps in the foregoing method embodiments, which will not be repeated here. The computer-readable storage medium may be read-only memory (ROM), random access memory (RAM), CD-ROM, magnetic tape, floppy disk, optical data storage device, or the like.

In addition, the above-mentioned drawings are only schematic illustrations of the processes included in the method according to the exemplary embodiment of the present disclosure, and are not intended to limit the disclosure. It can be easily understood that the processes shown in the above drawings do not indicate or limit the sequential order of these processes. In addition, it can be also easily understood that these processes may be performed synchronously or asynchronously, for example, in multiple modules.

After considering the description and practicing the disclosure herein, those skilled in the art can easily think of other embodiments of the present disclosure. The present disclosure is intended to cover any variations, uses, or adaptive changes of the present disclosure that follow the general principles of the present disclosure and include common general knowledge or customary technical means in the technical field not disclosed in the present disclosure. The description and examples are to be considered exemplary only, and the true scope and spirit of this disclosure are defined by the appended claims.

What is claimed is:

1. An automatic image capturing method, comprising:
obtaining an image-to-be-processed;
pre-processing the image-to-be-processed to obtain a pre-processing result;
inputting the pre-processing result into a trained machine learning model for classification; and
generating and transmitting a control signal according to the classification, the control signal being configured to perform a preset operation to the image-to-be-processed.

2. The method according to claim 1, wherein pre-processing the image-to-be-processed to obtain the pre-processing result comprises:
performing scene understanding to the image-to-be-processed to obtain a scene classification result.

3. The method according to claim 2, wherein the scene classification result comprises one of: a seaside, a forest, a city, an indoor space, and a desert.

4. The method according to claim 1, wherein pre-processing the image-to-be-processed to obtain the pre-processing result comprises:
performing object detection to the image-to-be-processed to obtain a target object in the image-to-be-processed.

5. The method according to claim 4, wherein pre-processing the image-to-be-processed to obtain the pre-processing result further comprises:
tracking the target object to obtain a tracking result.

6. The method according to claim 4, wherein pre-processing the image-to-be-processed to obtain the pre-processing result further comprises:
performing posture analysis to the target object to obtain an action category of the target object.

7. The method according to claim 6, wherein the action category of the target object comprises one of: running, walking, and jumping.

8. The method according to claim 1, wherein pre-processing the image-to-be-processed to obtain the pre-processing result comprises:
performing image quality analysis to the image-to-be-processed to obtain image quality of the image-to-be-processed.

9. The method according to claim 1, wherein generating and transmitting a control signal according to the classification, the control signal being configured to perform the corresponding preset operation to the image-to-be-processed comprises:
in response to the classification being in the first classification, saving the image-to-be-processed; and
in response to the classification being in the second classification, deleting the image-to-be-processed.

10. The method according to claim 9, wherein generating and transmitting the control signal according to the classification, the control signal being configured perform the corresponding preset operation to the image-to-be-processed further comprises:
in response to the classification being in the third classification, obtaining corresponding photographing adjustment parameters according to the image-to-be-processed; and
deleting the image-to-be-processed, and obtaining another image-to-be-processed according to the photographing adjustment parameters.

11. The method according to claim 10, wherein the photographing adjustment parameters comprise any one or more of: an aperture adjustment amount, an exposure parameter, a focal distance, or a photographing angle.

12. An automatic image capturing device, comprising:
an image acquisition module configured to obtain an image-to-be-processed;
a pre-processing module configured to pre-process the image-to-be-processed to obtain a pre-processing result;
a classification module configured to input the pre-processing results into a trained machine learning model for classification;
a control module configured to generate and transmit a control signal according to the classification, the control signal being configured to perform a preset operation to the image-to-be-processed.

13. The device according to claim 12, wherein the pre-processing module comprises:
a scene classification unit configured to perform scene understanding to the image-to-be-processed to obtain a scene classification result of the image-to-be-processed.

14. The device according to claim 12, wherein the pre-processing module comprises:
a detection unit configured to detect the image-to-be-processed to obtain a target object in the image-to-be-processed.

15. The device according to claim 14, wherein the pre-processing module further comprises:
a tracking unit configured to track the target object and obtain a tracking result.

16. The device according to claim 14, wherein the pre-processing module further comprises:
a posture analysis unit configured to analyze the target object to obtain an action category of the target object.

17. The device according to claim 12, wherein the pre-processing module comprises:
a quality analysis unit configured to perform image quality analysis to the image-to-be-processed to obtain image quality of the image-to-be-processed.

18. The device according to claim 12, wherein the control module comprises:
a storage unit configured to save to the image-to-be-processed in response to the classification being in the first classification; and
a deletion unit configured to delete the image-to-be-processed in response to the classification being in the second classification.

19. The apparatus of claim 18, wherein the control module further comprises:
an adjustment unit configured to obtain corresponding photographing adjustment parameters according to the image-to-be-processed in response to be the classification being in the third classification; and
a retake unit configured to delete the image-to-be-processed to obtain another image-to-be-processed according to the photographing adjustment parameters.

20. A UAV, comprising:
a body;
a photographing device disposed on the body; and
a processor configured to:
obtain an image-to-be-processed;
pre-process the image-to-be-processed to obtain a pre-processing result;
input the pre-processing result into a trained machine learning model for classification; and
generate and transmit a control signal according to the classification, the control signal being configured to perform a preset operation to the image-to-be-processed.
